(19) United States
(12) Patent Application Publication
(10) Pub. No.: US 2026/0326237 A1
(43) Pub. Date: Oct. 22, 2026

(54) MATERIAL POWDER NOZZLE FOR A LASER CLADDING DEVICE, LASER CLADDING DEVICE, AND METHOD FOR LASER CLADDING

(71) Applicant: TRUMPF Laser- und Systemtechnik SE, Ditzingen (DE)

(72) Inventors: Andreas Scholz, Taunusstein (DE); Nicolai Speker, Pleidelsheim (DE); Bjoern Sautter, Leonberg (DE)

(21) Appl. No.: 19/703,130

(22) Filed: Jun. 10, 2026

Related U.S. Application Data
(63) Continuation of application No. PCT/EP2024/084114, filed on Nov. 29, 2024.

(30) Foreign Application Priority Data
Dec. 14, 2023 (DE) 10 2023 135 210.5

(51) Int. Cl. B23K 26/14; C23C 24/08

(52) U.S. Cl. CPC B23K 26/1476; C23C 24/085

(57) ABSTRACT

A material powder nozzle for a laser cladding device includes a nozzle outlet plane, a nozzle inlet plane that is spaced apart from the nozzle outlet plane in a Z direction, a powder focus plane that is spaced apart from the nozzle outlet plane in an opposite direction to the Z direction, and powder channels through which a mixture of a material powder and a transport gas can flow. A respective longitudinal center axis of each respective powder channel forms an elevation angle with respect to the nozzle outlet plane. The elevation angle is greater than 0°and less than 90°. The respective longitudinal center axis forms a respective azimuth angle with respect to a horizontal radial axis lying in the nozzle outlet plane. The respective azimuth angle is greater than 0°and less than 90°.

### CROSS REFERENCE TO RELATED APPLICATIONS

This application is a continuation of International Application No. PCT/EP2024/084114 (WO 2025/124933A1), filed on Nov. 29, 2024, and claims benefit to German Patent Application No. DE 10 2023 135 210.5, filed on Dec. 14, 2023. The aforementioned applications are hereby incorporated by reference herein.

### FIELD

Embodiments of the present invention relate to a material powder nozzle for a laser cladding device and a laser cladding device having such a material powder nozzle. Embodiments of the present invention also relate to a method for laser cladding, in which a laser cladding device having the material powder nozzle is used.

### BACKGROUND

In laser cladding—for example, in LMD (laser metal deposition) laser cladding, DMD (direct metal deposition) laser cladding, DED (direct energy deposition) laser cladding, HS-LMD (high-speed laser metal deposition) laser cladding, EHLA (extreme high-speed laser application) laser cladding, generative laser cladding, etc.—a welding material in the form of a material powder is blown into a process zone on or just above the surface of a workpiece by means of a transport gas jet, wherein the material powder or the welding material and/or the surface of the workpiece within the process zone is/are melted by means of a laser welding beam. This creates a fusion-metallurgical bond between the workpiece and the welding material. Conventional laser cladding processes are known from the prior art, for example from DE 10 2011 100 456 B4 or from DE 10 2018 130 798 A1.

To achieve a homogeneous energy distribution and a high-quality connection result, a laser welding beam with a round beam cross-section is used, for example a single-spot laser beam or a 2-in-1 fiber laser beam, each with a top-hat laser intensity profile. By means of a conventional material powder nozzle 100, as shown schematically in FIG. 10, the material powder is concentrated at one point in the process zone 200 (for example, on a workpiece surface), resulting in a Gaussian-like powder density profile 300 that does not match the top-hat laser intensity profile 400 of the laser welding beam. This is because in the area of powder accumulation 500 in the center of the powder density profile 300, the process zone 200 is more heavily shaded there than in the peripheral region 600 of the powder density profile 300. The powder density profile 300 results from a positional arrangement of powder channels of the conventional material powder nozzle 100, wherein the respective channel longitudinal center axis 700 of the powder channels lies in a respective plane spanned by a radius of the conventional material powder nozzle 100 and a horizontal axis x of the conventional material powder nozzle 100, whereby the channel longitudinal center axes 700 intersect each other and the horizontal axis x at a single, common point 800. In laser cladding, only a small amount of laser radiation reaches the workpiece surface due to the strongly shaded central process zone 200, which means that the workpiece in the process zone is not heated sufficiently, leading to bonding defects and/or delamination of the layer structure.

To address this problem, powder channels with a larger inner diameter than before can be used, but a higher transport gas volume flow rate is then required to ensure that the flight time of the material powder particles in the process or interaction zone does not change compared to conventional powder channels with a smaller inner diameter, and thus to keep the temperature of the material powder particles required to generate the fusion-metallurgical compound constant. This is inefficient, firstly with regard to the increased consumption of transport gas and secondly with regard to the amount of energy required to perform laser cladding. Furthermore, the entire workpiece or a large volume part of the workpiece can be heated by means of a heating device separate from the laser welding beam in order to promote the formation of the fusion-metallurgical bond. However, this means that a particularly large amount of energy is required to perform the laser cladding.

### SUMMARY

Embodiments of the present invention provide a material powder nozzle for a laser cladding device. The material powder nozzle includes a nozzle coordinate system having a horizontal origin plane and a vertical axis, a vertical nozzle longitudinal center axis that coincides with the vertical axis of the nozzle coordinate system, a nozzle outlet plane that coincides with the horizontal origin plane of the nozzle coordinate system, a nozzle inlet plane that is spaced apart from the nozzle outlet plane in a Z direction by a material powder nozzle height, a powder focus plane that is spaced apart from the nozzle outlet plane by a powder focal length in an opposite direction to the Z direction, and powder channels through which a mixture of a material powder and a transport gas can flow. A respective outlet aperture of each respective powder channel lies in the nozzle outlet plane. A respective inlet aperture of each respective powder channel lies in the nozzle inlet plane. A respective channel longitudinal center axis of each respective powder channel passes through an outlet aperture center point and an inlet aperture center point. The respective longitudinal center axis forms an elevation angle with respect to the nozzle outlet plane. The elevation angle is greater than 0° and less than 90°. The respective longitudinal center axis forms a respective azimuth angle with respect to a horizontal radial axis lying in the nozzle outlet plane. The respective azimuth angle is greater than 0° and less than 90°.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a nozzle coordinate system of a material powder nozzle of a laser welding device according to some embodiments, wherein a channel longitudinal center axis of a powder channel of the material powder nozzle is shown in isolation;

FIG. 2 shows a perspective view of the material powder nozzle according to some embodiments;

FIG. 3 shows a schematic view of the material powder nozzle along its nozzle longitudinal center axis according to some embodiments, wherein only the channel longitudinal center axes and the inlet and outlet apertures of the powder channels are shown of the material powder nozzle;

FIG. 4 shows a view of the material powder nozzle cut along a section plane IV-IV according to some embodiments (see FIG. 3);

FIG. 5a and FIG. 5b show a schematic view of the material powder nozzle according to some embodiments, which has a powder channel pair, each comprising two powder channels (FIG. 5a) and a schematic view of the material powder nozzle along its nozzle longitudinal center axis, wherein only the channel longitudinal center axes and the inlet and outlet aperture center points of the powder channels are shown of the material powder nozzle (FIG. 5b);

FIG. 6 shows a schematic view of the material powder nozzle along its nozzle longitudinal center axis according to some embodiments, wherein only the channel longitudinal center axes and the outlet aperture center points of the powder channels are shown of the material powder nozzle, and wherein three powder channels form an outer channel group and three further powder channels form an inner channel group;

FIG. 7 shows a schematic view of the material powder nozzle along its nozzle longitudinal center axis according to some embodiments, wherein only the channel longitudinal center axes and the outlet aperture center points of the powder channels are shown of the material powder nozzle, and wherein two outer channel groups are arranged along an outer aperture circle;

FIG. 8 shows a schematic view of the material powder nozzle, whose powder channels are arranged such that a top-hat powder density profile results on a powder focus plane during a laser welding process, according to some embodiments;

FIG. 9 shows a schematic view of the material powder nozzle, whose powder channels are arranged such that a concave powder density profile results on the powder focus plane during a laser welding process, according to some embodiments; and

FIG. 10 shows a schematic view of a conventional material powder nozzle, which is used to generate a Gaussian-like powder density distribution in a conventional laser welding process, according to some embodiments.

### DETAILED DESCRIPTION

Embodiments of the present invention provide a solution to produce a particularly stable and reliable connection between a workpiece and a welding material using laser cladding with the lowest possible energy input.

According to embodiments of the invention, a material powder nozzle for a laser cladding device and a laser cladding device comprising the material powder nozzle are proposed. Furthermore, a method for laser cladding using the laser cladding device is proposed. For the description of the material powder nozzle, reference is made to a nozzle coordinate system (r|z|φ) of the material powder nozzle, wherein, for the sake of a simple description, it is assumed here that an origin plane (Z-plane) of the nozzle coordinate system is arranged horizontally for an observer. The nozzle coordinate system and the material powder nozzle are fixed to each other, so that, when the material powder nozzle is rotated, its nozzle coordinate system rotates uniformly. Terms such as “vertical”, “horizontal”, etc. are accordingly used here to refer to the origin plane, which is referred to below as the horizontal origin plane. The nozzle coordinate system is, for example, a cylindrical coordinate system, in particular if the material powder nozzle has a cylindrical design and/or if powder channels of the material nozzle-as described below—are arranged along special circles.

The material powder nozzle has a vertical nozzle longitudinal center axis that coincides with a vertical axis of the nozzle coordinate system, wherein a nozzle outlet plane of the material powder nozzle and the horizontal origin plane of the nozzle coordinate system coincide. A nozzle inlet plane of the material powder nozzle is spaced from the nozzle outlet plane in the Z direction by a material powder nozzle height, whereas a powder focus plane of the material powder nozzle is spaced from the nozzle outlet plane or from the horizontal origin plane in the opposite direction to the Z direction by a powder focal length. Furthermore, the material powder nozzle has two or more powder channels, through each of which a mixture of material powder and transport gas can flow, the transport gas component of which includes, for example, helium, argon, nitrogen or a gas mixture. The mixture of material powder and transport gas flowing through the powder channels can also be referred to as a powder gas jet. In particular, the material powder nozzle has three or more powder channels, for example six, seven or eight, up to 20 or more. Accordingly, the material powder nozzle is designed as a multi-jet nozzle. The respective powder channel is, for example, 10 mm long or longer along its channel longitudinal center axis and has an inner diameter through which matter can flow of, for example, 0.5 mm to 5 mm.

Each powder channel has its outlet aperture in the nozzle outlet plane, and each powder channel has its inlet aperture in the nozzle inlet plane. A perfectly straight channel longitudinal center axis runs through an outlet aperture center point of the outlet aperture and through an inlet aperture center point of the inlet aperture, enclosing an elevation angle with the nozzle outlet plane that is greater than 0° and less than 90°. In addition, the channel longitudinal center axis with a horizontal radial axis of the nozzle coordinate system forms a respective azimuth angle lying in the nozzle outlet plane which is greater than 0° and less than 90°, in particular a maximum of 60°. The radial axis lies in the horizontal origin plane and intersects the vertical or Z-axis of the nozzle coordinate system. Therefore, the radial axis and a radius of the material powder nozzle coincide.

The powder channels can be rigidly arranged in a carrier body of the material powder nozzle made of hard metal, glass or copper, for example as a respective through-opening that completely penetrates the carrier body along the respective channel longitudinal center axis, or as a respective tube and/or hose element made of hard metal, glass or copper, the ends of which are fixed to the carrier body. This makes the material powder nozzle robust against laser reflections from laser cladding and results in very few moving components that can be worn down by powder contamination. Alternatively, an adjustment mechanism may be provided which is designed to adjust the positional position of the respective powder channel, in particular its azimuth and/or elevation angle. This allows for flexible adjustment of a powder focus diameter and powder density distribution to a change in a laser beam spot diameter and laser beam profile, without having to change the material powder nozzle, which would require an unproductive downtime of the laser cladding device. The channel longitudinal center axes of the powder channels can each form the same azimuth and/or elevation angle, thus being arranged similarly in a geometric sense. This means that if one channel longitudinal center axis were rotated around the vertical axis into the other of the channel longitudinal center axes, the two channel longitudinal center axes would coincide. Alternatively, it is provided that the channel longitudinal center axes each form an individual azimuth and/or elevation angle.

In the laser cladding process, the laser cladding device is used, wherein a welding material in the form of material powder is fed into a transport gas jet by means of a powder conveying unit, creating the mixture of material powder and transport gas, which is introduced into the respective powder channel through the respective inlet aperture, flows through the channel and is expelled from the powder channel through the associated outlet aperture. Furthermore, it is conceivable that each powder channel has, in addition to the inlet and outlet aperture, an additional inlet aperture, wherein, during laser cladding, only transport gas is introduced into the powder channel through one of the inlet apertures and only material powder is introduced through the other inlet aperture, so that the mixture of material powder and transport gas is prepared directly within the powder channel. It may be provided that two or more different welding materials are introduced into the process zone simultaneously, wherein the respective welding materials are supplied to the process zone in a pure form through their respective assigned powder channels.

The laser cladding device generates a laser welding beam which has in particular a wavelength range of 0.8 μm to 2 μm and a beam quality of 4 mm·mrad to 50 mm·mrad. A 2-in-1 fiber optic laser or a single-core fiber laser can be used. Using laser optics, the laser welding beam is focused onto a process zone, wherein the powder focus plane, the process zone and the surface of the workpiece are arranged to coincide with each other. The focus diameter on the powder focus plane or on the workpiece surface is, for example, 0.3 mm to 20 mm. In particular, it is provided that the process zone or powder focus plane and the material powder nozzle are spaced apart from each other by a constant powder focal length during the laser cladding process. The mixture of material powder and transport gas flowing out of the powder channels and into the process zone is heated by the laser welding beam directly above the process zone, thereby heating a portion of the material powder in the mixture of material powder and transport gas. The heated material powder then partially impacts the workpiece in a molten state. In particular, it is provided that the laser welding beam passes along the nozzle longitudinal center axis through a material-free laser passage of the material powder nozzle.

Due to the azimuthal orientation of the powder channels of the material powder nozzle, the mixture of material powder and transport gas flowing out of the powder channels generates a powder density profile in the powder focus plane or process zone that deviates from a Gaussian-like powder density profile. For example, for a laser welding beam that has a top-hat laser intensity profile in the powder focus plane, a top-hat powder density profile is generated in the powder focus plane. Alternatively or additionally, for a laser welding beam that has a ring-shaped laser intensity profile in the powder focus plane, a concave powder density profile is generated for the laser welding beam in the powder focus plane.

This results in a more uniform shading of the workpiece surface, thereby improving the fusion-metallurgical bond between the welding material applied to the workpiece and the workpiece itself. This results—viewed over a cross-section of the process zone-in a more uniform application of the welding material due to a more uniform powder density. The powder density profile and the laser intensity profile are better matched than before.

According to a possible further development of the material powder nozzle, two of the channel longitudinal center axes intersect in the powder focus plane at a location offset from the nozzle longitudinal center axis or vertical axis. In other words, the two powder channels whose channel longitudinal center axes intersect in the powder focus plane form a powder channel pair, with the powder channels of the powder channel pair enclosing an opposite azimuth angle. In this case, the magnitude of one azimuth angle and the magnitude of the other azimuth angle are the same, but the two azimuth angles have different signs. Two or more such powder channel pairs can be provided. In particular, another of the channel longitudinal center axes is provided, which is skew to the channel longitudinal center axes intersecting in the powder focus plane. This enables a particularly advantageous adjustment of the powder density profile without swirl in the powder gas jet.

In another possible embodiment, an outer aperture circle and an inner aperture circle lying in the powder focus plane are disclosed, the circle center points of which coincide on the nozzle longitudinal center axis or vertical axis, respectively, with the outer aperture circle having a larger radius than the inner aperture circle. An outer channel group is formed by two or more of the powder channels, in which the respective channel longitudinal center axis of the powder channels belonging to the outer channel group and the powder focus plane form a respective outer intersection point. The outer intersection points are equidistant from each other along at least one partial circular arc of the outer aperture circle. Two or more outer channel groups may be provided, which are equidistant from each other, particularly along the outer aperture circle. Alternatively or additionally, an inner channel group is formed by two or more of the powder channels, in which the respective channel longitudinal center axis of the powder channels belonging to the inner channel group and the powder focus plane form a respective inner intersection point, wherein the inner intersection points are equidistantly spaced from each other along at least one partial circular arc of the inner aperture circle. Two or more inner channel groups may be provided, which are equidistant from each other, particularly along the inner aperture circle. In this way, a large powder jet spot is created in the process zone or on the powder focus plane during laser cladding. For this purpose, only small powder channel inner diameters are advantageously required, and an almost pure material powder is introduced into a process zone center (towards which the powder channels of the inner channel group are directed) or into a process zone outer ring (towards which the powder channels of the outer channel group are directed). This prevents unwanted mixing of the welding materials.

To make it particularly easy to connect the powder conveyor to the powder channels, another possible embodiment provides that the inlet apertures are arranged along an inlet aperture circle lying in the nozzle inlet plane, the circle center point of which coincides with the nozzle longitudinal center axis or vertical axis, with the inlet apertures being equidistant from each other along the entire inlet aperture circle.

According to another possible embodiment, the material powder nozzle has, in addition to the powder channels which-as described above-are arranged with an azimuth angle of 0° (exclusive of) to 90° (exclusive of), a further powder channel or two or more further powder channels, wherein each channel longitudinal center axis forms an azimuth angle of exactly 0° with the radial axis. In other words, the channel longitudinal center axis of each subsequent powder channel lies in the plane defined by the vertical and radial axes of the nozzle coordinate system. In this way, a portion of the mixture of material powder and transport gas flowing through at least one other powder channel can be directed precisely into the center of the process zone. This results in an even more uniform top-hat powder density profile in the process zone or on the powder focus plane.

In a further possible embodiment, the entirety of the powder channels of the material powder nozzle has up to six different types of powder channels: Each powder channel of the first type is shaped as a straight or oblique prism which has a polygonal base. Each powder channel of the second type is shaped as a straight or oblique cylinder which has an oval base. Each powder channel of the third type is shaped as a truncated pyramid which has a polygonal base, wherein the powder channel of the third type is designed to converge from the nozzle inlet plane towards the nozzle outlet plane. Each powder channel of the fourth type is shaped as a truncated pyramid which has a polygonal base, wherein the powder channel of the fourth type is designed to diverge from the nozzle inlet plane towards the nozzle outlet plane. Each powder channel of the fifth type is shaped as a truncated cone which has an oval base, wherein the powder channel of the fifth type is designed to converge from the nozzle inlet plane towards the nozzle outlet plane. Each powder channel of the sixth type is shaped as a truncated cone which has an oval base, wherein the powder channel of the sixth type is designed to diverge from the nozzle inlet plane towards the nozzle outlet plane. The base of one or more of the powder channels of the first, third, and/or fourth type is, for example, rectangular, in particular square. Other polygons, in particular those which deviate from a rectangle, are also conceivable as the base of the corresponding powder channel. The base of one or more of the powder channels of the second, fifth, and/or sixth type is, for example, circular in shape. Ovals which deviate from a circle, in particular ellipses, are also conceivable as the base of the corresponding powder channel. By shaping the appropriate geometry of the powder channels, further influence can be exerted on the powder density distribution.

Further advantages, features and details of the embodiments of the invention are specified in the following description of possible exemplary embodiments and the drawing. The features and combinations of features mentioned above in the description as well as the features and combinations of features revealed below in the description of the figures and/or in the figures alone can be used not only in the combination indicated in each case, but also in other combinations or on their own, without departing from the scope of the invention.

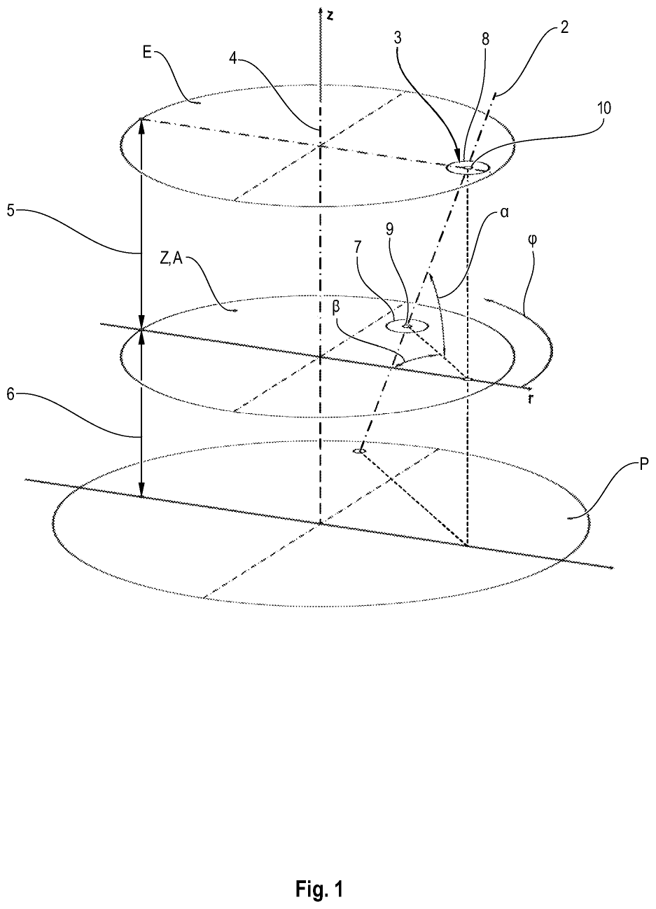

With reference to FIG. 1 to FIG. 9, a material powder nozzle 1, a laser welding device comprising the material powder nozzle 1 (not shown) and a method for laser cladding are described below in a joint description. Identical or functionally identical elements are designated with the same reference signs in the FIGS. 1-9.

FIG. 1 shows a nozzle coordinate system r|z|φ designed as a cylindrical coordinate system of the material powder nozzle 1, which has two or more powder channels 3. A channel longitudinal center axis 2 of one of the powder channels 3 of the material powder nozzle 1 is shown in isolation. A radial axis r lies in a horizontal origin plane Z of the nozzle coordinate system, wherein the radial axis r and a vertical axis z of the nozzle coordinate system intersect perpendicularly at the origin of the nozzle coordinate system located in the horizontal origin plane Z. With respect to the origin, the position of each point within the nozzle coordinate system is uniquely defined by means of a horizontal coordinate (along the radial axis r), a vertical coordinate (along the vertical axis z) and an orientation angle φ. The following applies to the further description:
A vertical nozzle longitudinal center axis 4 of the material powder nozzle 1 and the vertical axis z coincide.
The nozzle outlet plane A of the material powder nozzle 1 and the horizontal origin plane Z coincide.
A nozzle inlet plane E of the material powder nozzle 1 is spaced from the nozzle outlet plane A or horizontal origin plane Z in the Z direction by a material powder nozzle height 5.
A powder focus plane P of the material powder nozzle 1 is spaced from the nozzle outlet plane A or horizontal origin plane Z in the opposite direction to the Z direction by a powder focal length 6.
An outlet aperture 7 of the respective powder channel 3 lies in the nozzle outlet plane A.
An inlet aperture 8 of the respective powder channel 3 lies in the nozzle inlet plane E.

It can also be seen in FIG. 1 that the completely straight channel longitudinal center axis 2 of the powder channel 3 passes through both an outlet aperture center point 9 of the outlet aperture 7 and an inlet aperture center point 10 of the inlet aperture 8. The channel longitudinal center axis 2 forms an elevation angle α with the nozzle outlet plane A, which is greater than 0° and less than 90°. Furthermore, the channel longitudinal center axis 2 forms an azimuth angle β lying in the nozzle outlet plane A with the radial axis r, which is greater than 0° and less than 90°.

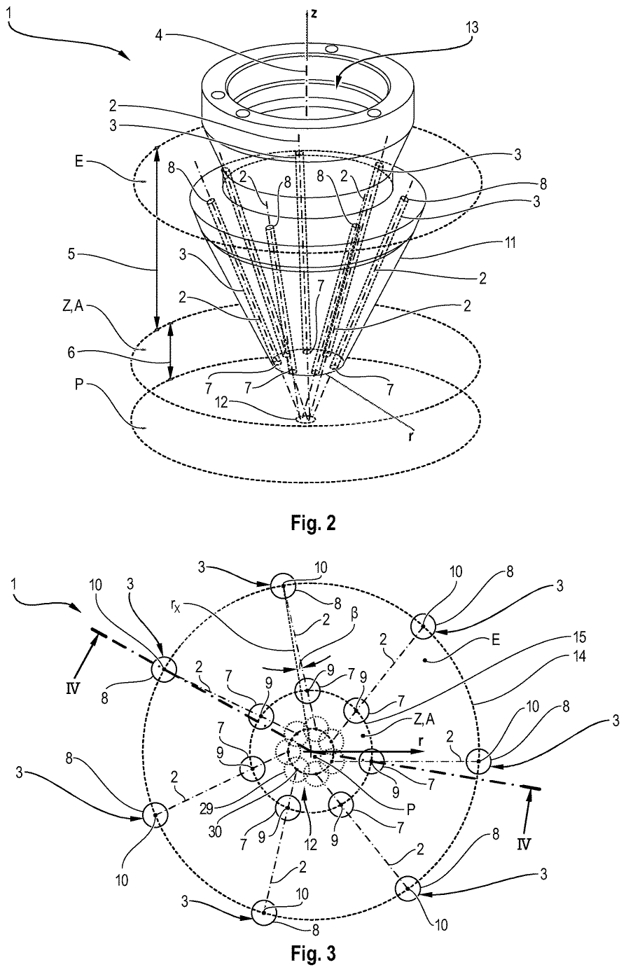

FIG. 2 shows a perspective view of the material powder nozzle 1, here in the example with seven powder channels 3, of which not all are provided with the corresponding reference sign for the sake of clarity. The powder channels 3 are each, for example, 10 mm long or longer and each have an inner diameter through which matter can flow of 2 mm or more. The powder channels 3 are rigidly arranged in a carrier body 11 of the material powder nozzle 1 made of hard metal, glass or copper, in that the respective powder channel 3 is designed as a through-opening, for example a through-bore, which completely penetrates the carrier body 11 along the respective channel longitudinal center axis 2. A variant of the material powder nozzle 1, not shown in the figure, has an adjustment mechanism by means of which the positional position of the respective powder channel 3, in particular its angles α, β, can be adjusted. The channel longitudinal center axes 2 of the powder channels 3 arranged according to FIG. 2 each form the same azimuth angle α and elevation angle β, and are therefore arranged similarly in a geometric sense. This means that if one of the channel longitudinal center axes 2 shown in FIG. 2 is rotated about the vertical axis z into another of the channel longitudinal center axes 2, the two channel longitudinal center axes 2 would coincide.

In the laser cladding process, the laser cladding device is used, wherein a welding material in the form of material powder is fed into a transport gas jet by means of a powder conveying unit, creating the mixture of material powder and transport gas, which is introduced into the respective powder channel 3 through the respective inlet aperture 8, flows through the channel and is expelled from the powder channel 3 through the associated outlet aperture 7, whereby the mixture of material powder and transport gas is blown onto the powder focus plane P, specifically into a process zone 12 located in the powder focus plane P. The laser cladding device generates a laser welding beam (not shown) which has, for example, a wavelength range of 0.8 μm to 2 μm and a beam quality of 4 mm·mrad to 50 mm·mrad. A 2-in-1 fiber optic laser or a single-core fiber laser can be used. By means of a laser optic (not shown) the laser welding beam is focused on the process zone 12, wherein the powder focus plane P, the process zone 12 and a surface of a workpiece, onto which the welding material is welded, are arranged to coincide with each other. The focus diameter on the powder focus plane P or on the workpiece surface is, for example, 0.3 mm to 20 mm. The process zone 12 or powder focus plane P and the material powder nozzle 1 are spaced apart from each other by the constant powder focal length 6 during the laser cladding process. The mixture of material powder and transport gas flowing out of the powder channels 3 and into the process zone 12 is heated by the laser welding beam directly above the process zone 12, thereby heating a portion of the material powder in the mixture of material powder and transport gas. The heated material powder then partially impacts the workpiece in a molten state. The laser welding beam passes along the nozzle longitudinal center axis 4 through a material-free laser passage 13 of the material powder nozzle 1.

FIG. 3 shows a schematic view of the material powder nozzle 1 along its nozzle longitudinal center axis 4, wherein only the channel longitudinal center axes 2 and the apertures 7, 8 of the powder channels 3 are shown of the material powder nozzle 1. The azimuth angle β is shown as a representative example for all of the powder channels 3 or channel longitudinal center axes 2 shown in FIG. 3, on one of the powder channels 3. It can be seen that the respective channel longitudinal center axis 2 and the radial axis r of the material powder nozzle 1, which originates perpendicularly from the vertical axis z or nozzle longitudinal center axis 4, diverge and form the azimuth angle β together. In the figures, r_{X} represents a rotational projection of the radial axis r belonging to the respective powder channel 3, which, like the radial axis r, originates from the vertical axis z or nozzle longitudinal center axis 4. Therefore, the corresponding azimuth angle β occurs between the projection r_{X} of the radial axis r and the associated channel longitudinal center axis 2. It can also be seen in FIG. 3 that the inlet apertures 8 are arranged along an inlet aperture circle 14 lying in the nozzle inlet plane E, the circle center point of which coincides with the nozzle longitudinal center axis 4 or vertical axis z, wherein the inlet apertures 8 are equidistantly spaced apart from each other along the entire inlet aperture circle 14. Furthermore, the outlet apertures 7 are arranged along an outlet aperture circle 15 lying in the nozzle outlet plane A, the circle center point of which coincides with the nozzle longitudinal center axis 4 or vertical axis z, wherein the outlet apertures 7 are equidistantly spaced from each other along the entire outlet aperture circle 15.

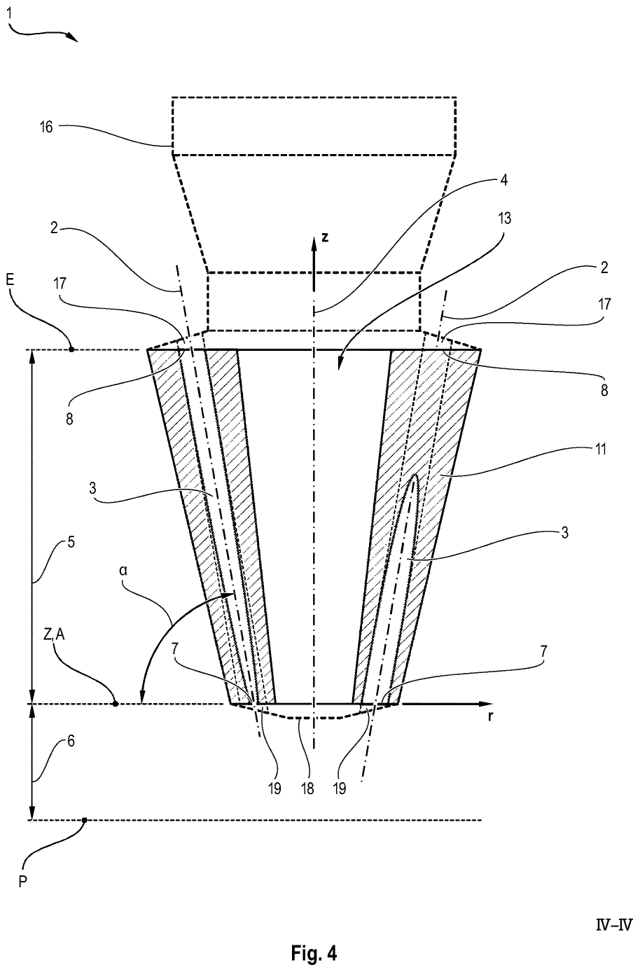

FIG. 4 shows a view of the material powder nozzle 1 cut along a section plane IV-IV (see FIG. 3), where the respective positions of the powder channels 3 and their apertures 7, 8 are particularly easy to see. Furthermore, it can be seen from FIG. 4 that the powder channels 3 in this example are each shaped as a straight circular cylinder. This means that the respective powder channel 3 is formed rotationally symmetrically within the carrier body 11, wherein the apertures 7, 8 located in the planes A and E appear as ellipses when the material powder nozzle 1 is viewed in the direction opposite to the Z-axis.

It is also conceivable that the material powder nozzle 1 has a powder channel 3 which is shaped as a straight or oblique prism. Alternatively or additionally, the material powder nozzle can have a further powder channel 3 which is shaped as a straight or oblique cylinder having an oval base that deviates from a circular disk. A supplementary or alternative powder channel 3 is shaped as a truncated pyramid, wherein this powder channel is designed to converge from the nozzle inlet plane E towards the nozzle outlet plane A. Alternatively or additionally, the material powder nozzle 1 can include a powder channel 3 which is shaped as a truncated pyramid, wherein this powder channel is designed to diverge from the nozzle inlet plane E towards the nozzle outlet plane A. Furthermore, a further powder channel 3 can be provided, which is shaped as a truncated cone and is designed to converge from the nozzle inlet plane E towards the nozzle outlet plane A. Additionally or alternatively, a further powder channel 3 is shaped as a truncated cone, which diverges from the nozzle inlet plane E towards the nozzle outlet plane A. It is to be understood that an entirety of the powder channels 3 of the material powder nozzle 1 consists of one or more of the above-mentioned types of powder channels 3.

Starting from the nozzle inlet plane E, a flange section 16 of the material powder nozzle 1 can be connected to the carrier body 11 in the Z direction, by means of which the material powder nozzle 1 and a nozzle flange of the laser cladding device can be or is connected together for laser cladding. The flange section 16, for example, has first channel extensions 17 that communicate fluidically with the inlet apertures 8, by means of which the powder conveying unit and the powder channels 3 are coupled together. Starting from the nozzle outlet plane A, a nozzle end body 18 of the material powder nozzle 1 can be connected to the carrier body 11 in the opposite direction to the Z direction, which has second channel extensions 19 communicating with the outlet apertures 7. The carrier body 11, the flange section 16 and the nozzle end body 18 are materially bonded together, in this case formed in one piece.

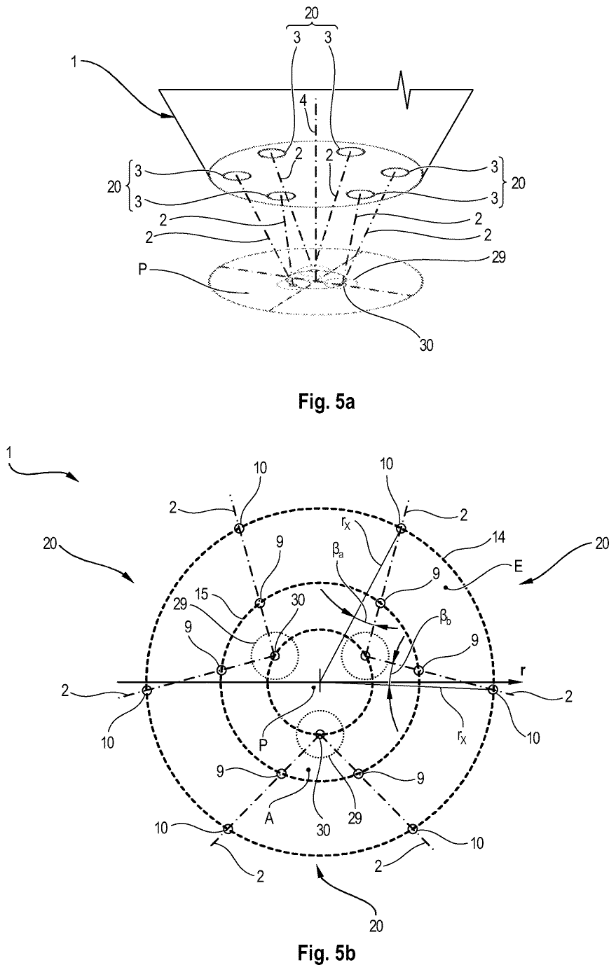

FIG. 5a shows a schematic view of the material powder nozzle 1, which has one powder channel pair 20 or more-in this case three-powder channel pairs 20, each with two powder channels 3. The two channel longitudinal center axes 2 of the respective powder channel pair 20 intersect each other away from the nozzle longitudinal center axis 4, as can be seen in FIG. 5a. The powder channel pairs 20 may be formed identically, that is, geometrically similar, as shown in FIG. 5a. In this case, the powder channels 3, or the channel longitudinal center axes 2 of the powder channel pair 20, form opposite azimuth angles βₐ, β_{b} with respect to each other, wherein the azimuth angles βₐ, β_{b} are equal in magnitude (|βₐ|=|β_{b}|) but have different signs (βₐ =−β_{b}). This can be seen particularly well in FIG. 5b, which shows a schematic view of the material powder nozzle 1 along its nozzle longitudinal center axis 4, wherein only the channel longitudinal center axes 2 and the aperture center points 9, 10 of the powder channels 3 or powder channel pairs 20 are shown of the material powder nozzle 1.

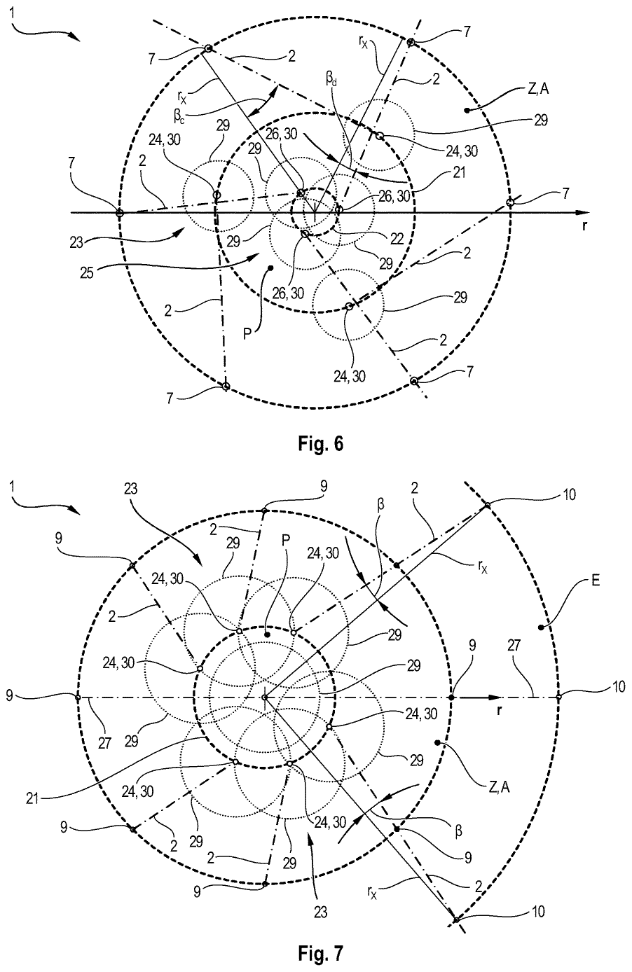

FIG. 6 shows a schematic view of the material powder nozzle 1 along its nozzle longitudinal center axis 4, wherein only the channel longitudinal center axes 2 and the outlet aperture center point 9 of the powder channels 3 are shown of the material powder nozzle 1. An outer aperture circle 21 lying in the powder focus plane P and an inner aperture circle 22 lying in the powder focus plane P are defined, the circle center points of which coincide on the nozzle longitudinal center axis 4 or vertical axis x. The outer aperture circle 21 has a larger radius than the inner aperture circle 22. Two or more of the powder channels 3—for example, three of the powder channels 3—form an outer channel group 23, in which the respective channel longitudinal center axis 2 of the powder channels 3 belonging to the outer channel group 23 and the powder focus plane P form a respective outer intersection point 24. The outer intersection points 24 are equidistant from each other along the outer aperture circle 21. Furthermore, according to the present example, an inner channel group 25 is formed by two or more of the other powder channels 3—here by three of the other powder channels 3—in which the respective channel longitudinal center axis 2 of the powder channels 3 belonging to the inner channel group 25 and the powder focus plane P form a respective inner intersection point 26, wherein the inner intersection points 26 are equidistantly spaced apart from each other along the inner aperture circle 22. Here, the respective channel longitudinal center axis 2 belonging to the outer channel group 23 forms a first azimuth angle β_{c} with the radial axis r or its projection r_{X}, while the respective channel longitudinal center axis 2 belonging to the inner channel group 25 forms a second azimuth angle β_{d} with the radial axis r or its projection r_{X}. The azimuth angles β_{c}, β_{d} can be equal or have the same magnitude. In this case, the first azimuth angle β_{c} is greater than the second azimuth angle β_{d}.

FIG. 7 shows a schematic view of the material powder nozzle 1 along its nozzle longitudinal center axis 4, wherein only the channel longitudinal center axes 2 and the outlet aperture center point 9 of the powder channels 3 are shown of the material powder nozzle 1, and wherein two outer channel groups 23 are arranged along the outer aperture circle 21. It can be seen that the two outer channel groups 23 each have three powder channels 3. The respective channel longitudinal center axis 2 belonging to the outer channel group 23 forms the azimuth angle β with the radial axis r or its projection r_{X}. It can further be seen that the outer intersection points 24 of the respective outer channel group 23 along the outer aperture circle 21, and in this case only along a partial circular arc of the outer aperture circle 21, are evenly spaced apart from each other. Furthermore, with reference to the entire outer aperture circle 21, the outer channel groups 23 are evenly spaced from each other.

FIG. 7 further shows that the material powder nozzle 1 can have, in addition to the powder channels 3 with the elevation angle α and the azimuth angle β, another powder channel whose azimuth angle is 0°. The material powder nozzle 1 can furthermore have two or more such additional powder channels. A channel longitudinal center axis 27 of the respective further powder channel and the radial axis r or its projection r_{X} coincide.

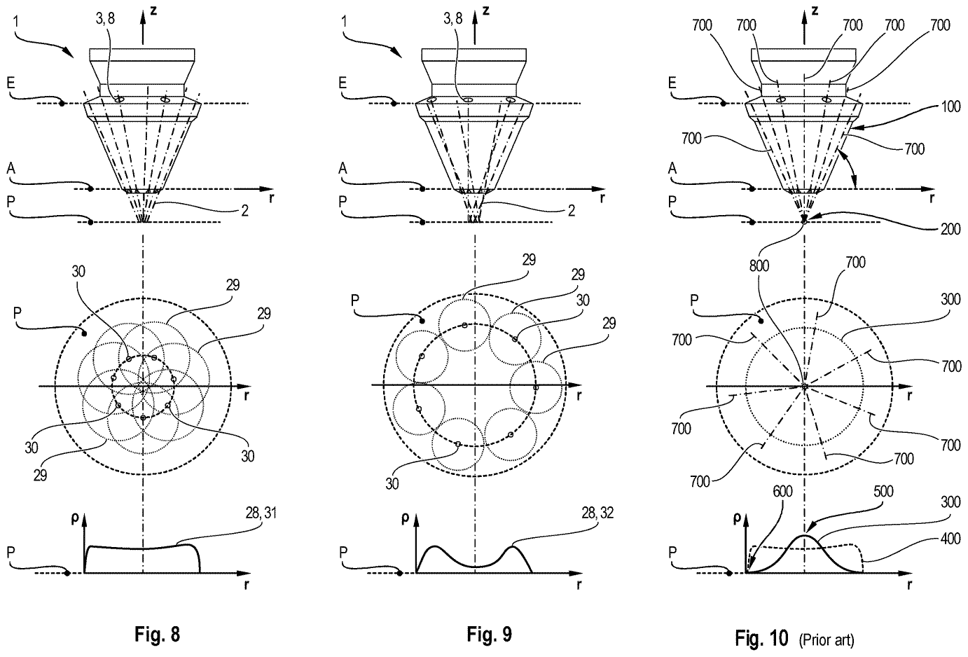

Due to the azimuthal orientation of the powder channels 3 of the material powder nozzle 1, the mixture of material powder and transport gas flowing out of the powder channels 3 generates a powder density profile 28 (see FIG. 8 and FIG. 9) in the powder focus plane P or process zone 12 that deviates from a Gaussian-like powder density profile 300 (see FIG. 10). Corresponding powder spots 29 together with their associated powder spot center points 30 are shown in FIG. 3 and FIG. 5 to FIG. 9.

FIG. 8 shows the material powder nozzle 1, in which the seven powder channels 3 are arranged such that, during laser cladding, for the laser welding beam having a top-hat laser intensity profile in the powder focus plane P, a top-hat powder density profile 31 is generated. FIG. 9 shows the material powder nozzle 1, in which the seven powder channels 3 are arranged such that, during laser cladding, for the laser welding beam having a ring-shaped laser intensity profile in the powder focus plane P, a concave powder density profile 32 is generated. Although only seven powder channels 3 are shown here, it can be understood that more or fewer powder channels 3 may be arranged in or on the material powder nozzle 1.

The material powder nozzle 1, the laser cladding device, and the laser cladding process each demonstrate a way in which a particularly stable and reliable connection between a workpiece and a welding material can be produced using laser cladding with the lowest possible energy input.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Material powder nozzle
2 Channel longitudinal center axis
3 Powder channel
4 Nozzle longitudinal center axis
5 Material powder nozzle height
6 Focal length
7 Outlet aperture
8 Inlet aperture
9 Outlet aperture center point
10 Inlet aperture center point
11 Carrier body
12 Process zone
13 Laser passage
14 Inlet aperture circle
15 Outlet aperture circle
16 Flange section
17 First channel extension
18 Nozzle end body
19 Second channel extension
20 Powder channel pair
21 Outer aperture circle
22 Inner aperture circle
23 Outer channel group
24 Outer intersection point
25 Inner channel group
26 Inner intersection point
27 Channel longitudinal center axis
28 Powder density profile
29 Powder spot
30 Powder spot center point
31 Top-hat powder density profile
32 Concave powder density profile
r|z|φ Nozzle coordinate system
Z Horizontal origin plane
x Horizontal axis
z Vertical axis
φ Orientation angle
A Nozzle outlet plane
E Nozzle inlet plane
P Powder focus plane
r, r_{X} Radial axis
β, βₐ, β_{b}, β_{c}, β_{d} Azimuth angle
α Elevation angle
100 Conventional material powder nozzle
200 Process zone
300 Gaussian-like powder density profile
400 Top-hat laser intensity profile
500 Powder accumulation
600 Peripheral region
700 Channel longitudinal center axis

1. A material powder nozzle for a laser cladding device, the material powder nozzle comprising:
a nozzle coordinate system having a horizontal origin plane and a vertical axis,
a vertical nozzle longitudinal center axis that coincides with the vertical axis of the nozzle coordinate system,
a nozzle outlet plane that coincides with the horizontal origin plane of the nozzle coordinate system,
a nozzle inlet plane that is spaced apart from the nozzle outlet plane in a Z direction by a material powder nozzle height,
a powder focus plane that is spaced apart from the nozzle outlet plane by a powder focal length in an opposite direction to the Z direction, and
powder channels through which a mixture of a material powder and a transport gas can flow, wherein
a respective outlet aperture of each respective powder channel lies in the nozzle outlet plane,
a respective inlet aperture of each respective powder channel lies in the nozzle inlet plane, and
a respective channel longitudinal center axis of each respective powder channel passes through an outlet aperture center point and an inlet aperture center point, the respective longitudinal center axis forms an elevation angle with respect to the nozzle outlet plane, the elevation angle being greater than 0° and less than 90°, the respective longitudinal center axis forms a respective azimuth angle with respect to a horizontal radial axis lying in the nozzle outlet plane, the respective azimuth angle being greater than 0° and less than 90°.

2. The material powder nozzle according to claim 1,
wherein
the channel longitudinal center axes of two of the powder channels intersect in the powder focus plane away from the nozzle longitudinal center axis.

3. The material powder nozzle according to claim 1,
wherein
an outer aperture circle lying in the powder focus plane and an inner aperture circle lying in the powder focus plane are defined, both a center point of the outer aperture circle and a center point of the inner aperture circle coinciding on the nozzle longitudinal center axis, wherein the outer aperture circle has a larger radius than the inner aperture circle, and wherein
two or more of the powder channels form an outer channel group, the respective channel longitudinal center axis of each respective powder channel of the outer channel group intersecting the powder focus plane at a respective outer intersection point, wherein the outer intersection points of the powder channels in the outer channel group are equidistant from each other along at least a first partial circular arc of the outer aperture circle, and/or
two or more of the powder channels form an inner channel group, the respective channel longitudinal center axis each respective powder channel of the inner channel group intersecting the powder focus plane at a respective inner intersection point, wherein the inner intersection points of the powder channels in the inner channel group are equidistant from each other along at least a second partial circular arc of the inner aperture circle.

4. The material powder nozzle according to claim 1,
wherein
the inlet apertures of the powder channels are arranged along an inlet aperture circle lying in the nozzle inlet plane, a center point of inlet aperture circle coinciding with the nozzle longitudinal center axis, wherein the inlet apertures are equidistantly spaced apart from each other along the inlet aperture circle.

5. The material powder nozzle according to claim 1, further comprising
a further powder channel, a channel longitudinal center axis of the further powder channel forming an azimuth angle of 0° with respect to the horizontal radial axis.

6. The material powder nozzle according to claim 1,
wherein
one of the powder channels is shaped as a prism, and/or
one of the powder channels is shaped as a cylinder with a base surface that deviates from a circular disk, and/or
one of the powder channels is shaped as a truncated pyramid, and/or
one of the powder channels is shaped as a truncated cone.

7. The material powder nozzle according to claim 6,
wherein
the powder channel shaped as a truncated pyramid or as a truncated cone is configured to converge or diverge from the nozzle inlet plane towards the nozzle outlet plane.

8. A laser cladding device comprising the material powder nozzle according to claim 1.

9. A method for laser cladding by using a laser cladding device according to claim 8, wherein a powder density profile deviating from a Gaussian-like powder density profile is generated in the powder focus plane by the mixture of the material powder and the transport gas flowing from the powder channels.

10. The method according to claim 9,
wherein
in the powder focus plane
for a laser welding beam that has a top-hat laser intensity profile in the powder focus plane, a top-hat powder density profile is generated, and/or
for a laser welding beam that has a ring-shaped laser intensity profile in the powder focus plane, a concave powder density profile is generated.
